(19) United States
(12) Patent Application Publication
(10) Pub. No.: US 2018/0301053 A1
(43) Pub. Date: Oct. 18, 2018

(54) INTERACTIVE ROBOT-AUGMENTED EDUCATION SYSTEM

(71) Applicant: Vän Robotics, Inc., Chapin, SC (US)

(72) Inventors: Laura Boccanfuso, Austin, TX (US); Brandon Hudik, Bordentown, NJ (US)

(73) Assignee: Vän Robotics, Inc., Chapin, SC (US)

(21) Appl. No.: 15/955,869

(22) Filed: Apr. 18, 2018

Related U.S. Application Data
(60) Provisional application No. 62/486,569, filed on Apr. 18, 2017.

(51) Int. Cl. G09B 7/04; G09B 5/06; A63H 3/00

(52) U.S. Cl. CPC G09B 7/04; A63H 2200/00; A63H 3/003; G09B 5/065

(57) ABSTRACT

An interactive robot-augmented education system designed to promote self-paced, student-driven learning capable of encouraging students using embodied, expressive social interactions, individualized content, attentional tracking and adaptive guidance during each lesson.

### BACKGROUND OF THE INVENTION

### 1) Field of the Invention

The present invention relates to robot-augmented education systems, and more particularly, to a low cost interactive robot and web application teaching system designed to promote self-paced, student-driven learning capable of encouraging students using embodied, expressive social interactions, individualized content, attentional tracking and adaptive guidance during each lesson.

### 2) Description of Related Art

It is estimated that 1 in 5 elementary school-aged children now have a learning or attentional issue and, despite a number of government-sponsored programs such as the No Child Left Behind (NCLB) Act and Common Core, and spending approximately 39% more per student, the Program for International Assessment (PISA) recently ranked the US 36th in Math out of 64 countries globally (Breakspear, S. (2012) “The Policy Impact of PISA: An Exploration of the Normative Effects of Int'l Benchmarking in School System Performance. OECD Educ. Working Papers, No. 71.). Many children occasionally struggle with schoolwork during their K-8 school career and when poor grades result, children can become discouraged and avoid schoolwork. Parents who want to help their children may not have the necessary time or training and private tutoring can be expensive (Gut, G. F. and Monell, J. “Private Tutoring What Is Its Role in Independent School Education?” National Association of Independent Schools, http://www.nais.org/Magazines-Newsletters/ISMagazine/Pages/Private-Tutoring.aspx Accessed. Sep. 7, 2016).

Compounding these challenges, increased spending on education by families above the median income level has contributed to the widening achievement gap between students in the US (Reardon, S F. (2003) “The widening income achievement gap.” Educational Leadership 70.8: pp. 10-16.). Classroom instruction often focuses on meeting or exceeding district, state and/or federal standards such that, due to time constraints, the instructional focus is often referred to as “teaching to the middle” or “teaching to the test”, leaving little time to fulfill the needs of students who may need additional, individual help in order to master key concepts. Consequently, children who are struggling and are from more affluent families may catch up academically due to after school interventions, while others have limited opportunities to do so.

In particular, studies point to the significant role that anxiety plays in impeding math achievement, not only in higher grade levels but as early as fourth grade (Ashcraft, Mark H., Moore, Alex M. (2009) “Mathematics Anxiety and the Affective Drop in Performance”. Journal of Psychoeducational Assessment, No. 27, pp. 197., and, Wu, S., Amin H, Barth M., et. al. (2012) “Math Anxiety in Second and Third Graders and Its Relation to Mathematics Achievement”. Front in Psychology, No. 3, pp. 162.). Additional findings characterize the nature of math anxiety and suggest that students' angst is detrimental to math achievement irrespective of whether children experience anxiety related to number manipulation or to the social experience of actually doing mathematics (Wu et al, 2012). A growing body of work demonstrates the effectiveness of robot-augmented teaching pedagogies for improving academic performance (Saerbeck, M., Schut, T., Bartneck, C., & Janse, M. D. (2010) Expressive robots in education: varying the degree of social supportive behavior of a robotic tutor. In Proceedings of the SIGCHI Conference on Human Factors in Computing Systems, pp. 1613-1622; Han, J., Jo, M., Park, S., & Kim, S. (2005) The educational use of home robots for children. Workshop on Robot and Human Interactive Communication (ROMAN), pp. 378-383; Mubin, O., et al. (2013) “A review of the applicability of robots in education.” Journal of Technology in Education and Learning, 209-0015.; Leyzberg, D., Spaulding, S., Toneva, M., and Scassellati, B. (2012). The Physical Presence of a Robot Tutor Increases Cognitive Learning Gains. Cognitive Science Society, pp. 1882-1887.; Ramachandran, A. & Scassellati, B. (2014). Adapting Difficulty Levels in Personalized Robot-Child Tutoring Interactions: Machine Learning for Interactive System, Workshop at AAAI; Ramachandran, A. and Scassellati, B. (2016). Long-term Child-Robot Tutoring Interactions: Lessons Learned. To appear in: Long-Term Child-Robot Interaction (LTCRI) Workshop at IEEE International Symposium on Robot and Human Interactive Communication (RO-MAN. Liles, K. R., & Beer, J M. (in press). “Measuring the feasibility of Ms. An, the robot teaching assistant for rural minority students.” Human Factors and Ergonomics Society (HFES); Liles, K. R., & Beer, J M. (2015). Ms. An, feasibility study with a robot teaching assistant. ACM/IEEE International Conference on Human-Robot Interaction, 83-84.)

Although many educational technologies rely on screen-based interactions or focus on STEM-based learning with robot kits, when compared to embodied agents, they are not as effective or engaging (Lusk, M. M., & Atkinson, R. K. (2007). Animated pedagogical agents: Does their degree of embodiment impact learning from static or animated worked examples?. Applied cognitive psychology, 21(6), 747-764.). Another significant limitation of these practices is that they do not incorporate any social exchange that is so important to engaging learning pedagogies and do not provide social feedback (such as cheering) that has been found to be more motivating for the students to engage in the learning process (Han, J., & Kim, D. (2009). r-Learning services for elementary school students with a teaching assistant robot. In Human-Robot Interaction (HRI). pp. 255-256.). Finally, existing robot platforms require programming skills from the teachers or limited explanation of tasks which makes it hard for the teachers to incorporate these robots in the busy schedule of their classrooms (Eguchi, A. (2007). Educational Robotics for Elementary School Classroom. Technology and Teacher Education Annual, 18(5), 2542.).

Thus, many children struggle with schoolwork during their K-8 school career. When poor grades on assignments or assessments result, children can become discouraged or lose interest and avoid schoolwork. For some students, studying becomes increasingly stressful as it becomes associated with an expectation of failure or poor performance and an eroding confidence to succeed. Parents who are interested in helping their child succeed may not have the perspective, resources or training to know how to help their child. Some families opt for private tutoring, but for a large number of families, private tutoring is cost prohibitive. Other families turn to online resources. While web-based tools have proven effective for some students, these tools don't provide the attentional tracking, embodied positive feedback (high fives, fist bumps, clapping, dancing, etc) and adaptive delivery of lessons so critical for students who are already struggling to stay engaged and understand challenging topics.

Accordingly, it is an object of the present invention to provide a low cost interactive robot and web application teaching system for delivering supplemental education to students.

It is a further object of the present invention to provide a low cost interactive robot and web application teaching system designed to promote self-paced, student-driven learning capable of encouraging students using embodied, expressive social interactions, individualized content, attentional tracking and adaptive guidance during each lesson.

### SUMMARY OF THE INVENTION

The above objectives are accomplished according to the present invention by providing an interactive robot-augmented education system comprising an interactive robot device for providing embodied interactions with a user; a user computer device in communication with said robot device for delivering lesson information to the user in combination with said robot device; a user application operable on said user computer device that supports an interactive user interface enabling said robot device to display at least one of text, illustrations, audio and video, and combinations thereof, on said user computer device for delivering said lesson information; and, said robot device including a camera adapted to conduct attention tracking of the user's face and head position during delivery of said lesson information and to provide positive feedback and redirection to the user during delivery of said lesson information based on information obtained as a result of said attention tracking to focus the attention of said user on one of said robot device or said user computer device.

In a further advantageous embodiment, the robot device includes a chassis carrying a main control board having a camera interface, wherein said camera is operatively associated with said main control board through said camera interface to perform dynamic face detection, face tracking and head pose estimation to determine the focus of the user's attention during delivery of said lesson information.

In a further advantageous embodiment, said camera is rotatably carried on said robot device to provide for both vertical and horizontal rotation to facilitate facial tracking of said user.

In a further advantageous embodiment, said main control board includes an audio output connection, wherein a speaker is carried on said robot device and operatively associated with said main control board through said audio output connection to provide text-to-speech functionality in delivering lesson information and feedback to the user.

In a further advantageous embodiment, said main control board includes a wifi module allowing said robot device to act as a wireless access point for internet access and communication with a wifi-enabled user computer device to facilitate communication with said user application.

In a further advantageous embodiment, said robot device includes a torso, a pair of legs, a head, and a pair of arms mounted to said chassis, and wherein said head and arms are rotatably mounted on electric motors.

In a further advantageous embodiment, said main control board includes a series of motor connectors, wherein said electric motors rotating said head and arms are operatively associated with said main control board through said motor connectors to control rotation of the head and arms.

In a further advantageous embodiment, said robot device directs the user's attention at the beginning of delivering said lesson information to said user computer device and confirms the user's attention to a screen of said user computer device by requiring an on-screen task to continue with deliver of said lesson information to facilitate tracking of the user's face and head position.

In a further advantageous embodiment, said robot device tracks two targets of attention for the user consisting of said robot device itself and said screen of said user computer device, and wherein said robot device records where the user's attention is focused throughout deliver of said lesson information.

In a further advantageous embodiment, said lesson information is annotated to identify where the user's attention is expected to be directed for a given portion of said lesson information.

In a further advantageous embodiment, said robot device detects inattention of the user by determining whether an appropriate percentage of looking time to said robot device or screen of said user computer device has been performed by said user based on the specific portion of said lesson information being delivered.

In a further advantageous embodiment, said robot device initiates redirection behaviors directed to said user when inattention is detected to refocus the attention of the user on the appropriate target of said robot device or said screen of said user computer device.

In a further advantageous embodiment, said redirection behaviors comprise the robot device calling the user's name, verbally directing the user's attention to the appropriate learning target of the robot device or screen of the user computer device, or using nonverbal cues including pointing and head rotation to direct the user's attention to the appropriate learning target.

In a further advantageous embodiment, said robot device initiates game or break behaviors following a predetermined number of redirection attempts.

In a further advantageous embodiment, said robot device initiates positive reinforcement behaviors in the form of verbal feedback and nonverbal gestures upon successful completion of a lesson or an assignment.

In a further advantageous embodiment, said robot device initiates guidance behaviors in the form of lesson-specific verbal prompts during guided and user practice lessons to provide individualized guidance to lesson information.

In a further advantageous embodiment, said robot device accesses said lesson information through internet based resources and performs lesson content parsing and restructuring to create a lesson with a plurality of subsections for delivery to a user.

In a further advantageous embodiment, said plurality of subsections comprise an introduction portion, a guided practice portion, an independent practice portion, and an assessment portion.

In a further advantageous embodiment, the lesson information for each of said plurality of subsections is extracted from said internet based resources based the parsing of html tags used to format online data.

The above objectives are accomplished according to the present invention by providing an interactive robot-augmented education system comprising an interactive robot device for embodied interactions with a user, wherein said robot device accesses lesson information through internet based resources and performs lesson content parsing and restructuring to create a lesson for delivery to a user; a user computer device in communication with said robot device for delivering said lesson to the user in combination with said robot device; a user application operable on said user computer device that supports an interactive user interface to enable said robot device to display text, illustrations, audio and video on said user computer device for delivering said lesson information; and, said robot device including a camera adapted to conduct attention tracking of the user's face and head position during delivery of said lesson information and to provide positive feedback and redirection to the user during delivery of said lesson information based on information obtained as a result of said attention tracking to focus the attention of said user on one of said robot device or said user computer device.

### BRIEF DESCRIPTION OF THE DRAWINGS

The system designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a flow chart of the robot device behaviors according to the present invention;

FIG. 2 shows an image of a web form for a teacher's portal according to the present invention;

FIG. 3 shows an image of a web application content screen according to the present invention;

FIG. 4 shows a perspective view of an interactive robot device monitoring a user according to the present invention;

FIG. 5 shows an front view of an interactive robot device according to the present invention; and,

FIG. 6 shows a flow chart of lesson parsing details according to the present invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. While the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

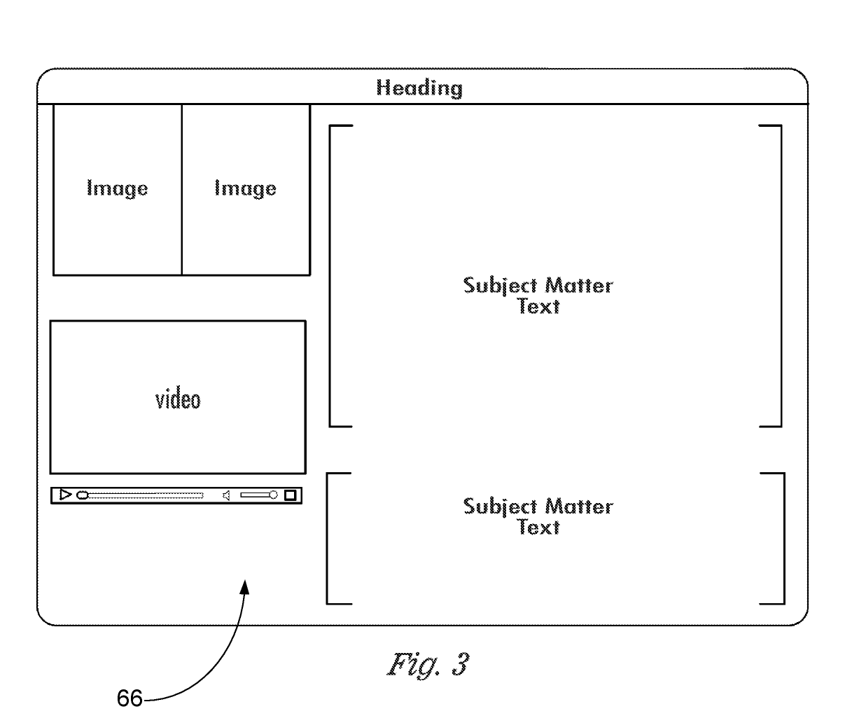

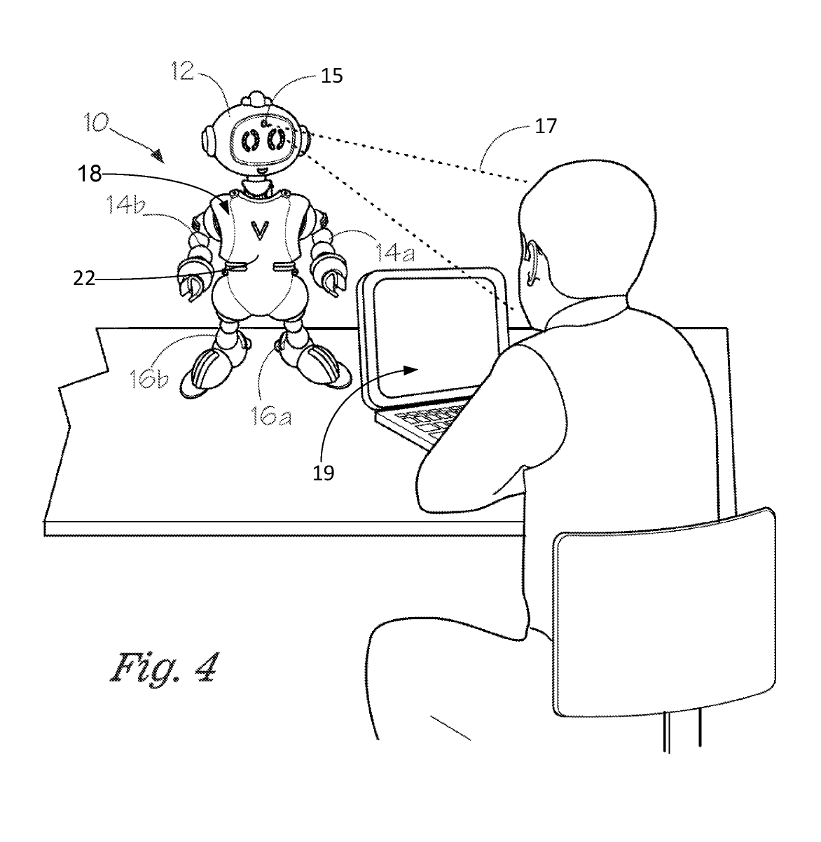

In one embodiment as best show in FIG. 4, the system of the present invention includes a physical interactive robot device (“robot”) 10 for embodied interactions with a user. The system further includes an accompanying user application (“webapp” or “web application”) 66 (FIG. 3) operable on a user computer device 19 in communication with the robot that supports an interactive user interface to enable the robot to display text, illustrations, audio and video to support each lesson. Preferably, the user computer device 19 is a PC, laptop, or tablet computer device that is wifi-enabled for wireless communication with the robot device 10. The user device 19 may be also be hardwired to the robot device 10. The robot device 10 itself operates as a wifi-enabled access point for communication with the user computer device 19 and providing internet access when connected to the internet. The robot device 10 connects wirelessly to the internet via communication with a wireless router access point, or even hardwired to a router, modem, or other internet access point as well know to those skill in the art. The system also includes a software platform supporting interactive robot behaviors, including but not limited to, receipt of lesson information (through email or USB enabled devices for example), online/offline lesson content parsing and restructuring for delivering a lesson to the user, as well as, attentional tracking, positive feedback/redirection, greetings, dancing, telling jokes and receiving direct commands from a connected wifi-enabled user computer device.

The interactive robot 10, which is preferably a desktop-sized unit, is expressly designed to adaptively deliver educational content using performance and attention tracking to maximize engagement and learning opportunities and provide embodied, one-on-one instruction at home or elsewhere. In one embodiment, the system leverages the sizable library of open-access internet based online content through the webapp by employing algorithms capable of intelligently parsing online lesson content information and then making it as easy as point-and-click for parents and educators to load new lesson content onto the interactive robot device. Compared to the state-of-the-art, the present invention greatly extends the breadth and utility of existing technologies by employing adaptive teaching techniques to individualize the delivery of instruction, and delivering a software platform that facilitates on-demand expansion of academic content.

The software platform for lesson content acquisition is coupled with the adaptive attentional and performance tracking of the interactive robot for maximizing learning opportunities, which greatly extends the long-term utility and performance of the robot-augmented education at a comparatively low, fixed cost to traditional methods. Additionally, by delivering a software platform which facilitates on-demand expansion of academic content, the robot will benefit more children and offer instruction across a broader range of skill levels. In one embodiment, educational content is obtained via open-access resources available over the internet, as well as but not limited to, partnerships with established educational content providers. In a preferred embodiment, the system employs computational techniques to intelligently parse the online lesson content sources published under the Creative Commons Attribution CC-BY and CC-BY-SA licenses and delivering these lessons to students through the interactive robot and wifi-enabled device with varying motivational and attentional ability using adaptive teaching techniques to optimize individual learning for each student.

There are three primary ways the system of the present invention facilitates education. First, the system promotes improved learning performance for elementary and middle school-aged children by intelligently delivering instruction using performance and attentional tracking, adaptive feedback, redirection and encouragement through the robot and user application interface. Second, an adaptive robot tutor, according to the present invention, reduces the overall burden for parents by acting as a customizable platform that accepts and delivers any subject matter lesson content, including but not limited to math, science and language arts, and which is further adaptable to cover a number of skill levels based on the child's individual learning pace and attentional level at a comparably low, fixed cost. Finally, the robot's software platform greatly expands its overall utility and increases its long-term value by providing on-demand expansion of academic content making it a useful resource for parents and teachers to use with a larger population of students and on an as-needed basis. Accordingly, the interactive robot and associated webapp education system can help fill in when a child is struggling with any particular subject matter or when s/he misses school due to illness, family emergency or travel.

The interactive robot-augmented education systems of the present invention is the first desktop-sized, relatively low-cost, social robot expressly designed to deliver personalized instruction using performance and attentional tracking to maximize learning opportunities and provide embodied, one-on-one instruction. In one embodiment, the robot's software consists of: (a) lesson parsing algorithms to intelligently deliver various lesson components to the user, (b) performance tracking system including expressive behaviors to reward or redirect students during practice and assessment, and (c) attention tracking system to track the head orientation and gaze direction of students during each lesson, including social behaviors such as bids for attention and offering incentives to complete the lesson (dance break, jokes, storytelling, etc).

In one embodiment, to operate the system: an on/off switch on the robot 10 is turned on, the robot then first checks for new lessons and updates the webapp 66 (FIG. 3) which is launched on the accompanying wifi-enabled user computer device 19, such as a computer tablet. Upon launching, a menu with available lessons is presented on the webapp. Next, the instructor or child selects the appropriate lesson and the robot launches the lesson. Upon completion of the lesson and assessment, the child's results are delivered, such as through email, to the teacher who originated the lesson. The system of the present invention is intended to supplement existing practices and resources. Compared to the state-of-the-art, the present invention greatly extends the breadth and utility of existing technologies by individualizing the delivery of instruction and delivering a software platform that facilitates on-demand expansion of academic content.

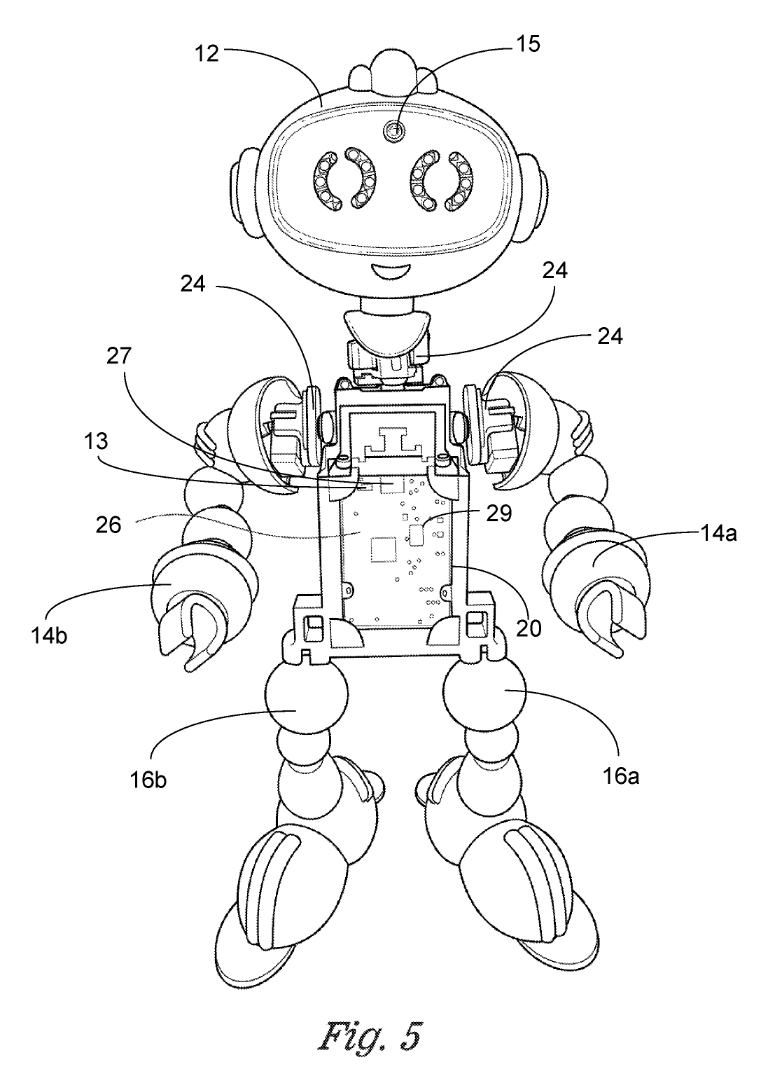

The interactive robot device (“robot”): Referring to FIGS. 4 and 5, an example embodiment of the robot device is shown. Robot device 10 includes a head portion 12, a pair of arms 14a, 14b, a pair of legs 16a, 16b, and a torso 18. Contained within torso 18 is a chassis 20 to which the various components of the robot are mounted. In the illustrated embodiment, torso 18 includes an exterior housing, designated generally as 22, which help to enclose and protect at least portions of chassis 20, as best shown in FIG. 4.

In one embodiment, the robot is built using a Raspberry Pi3B as a main control board 26, which mounts in chassis 20. The Raspberry Pi3B features a Quad Core Broadcom BCM2837 64-bit ARMv8 processor having a processor speed up to 1.2 GHz and a CSI camera interface, among other features. The main control board 26 further includes at least one motor connector 27, such as a DC MotorHat to augment the number of GPIO pins available for motor control. Preferably the robot included 2 DC MotorHats, thereby expanding the number of supportable motors from 2 to 8. In one embodiment, the robot is designed with a series DC electric motors 24 operatively connected to main control board 26 through motor connector 27, to allow for a pan/tilt platform in the arms and head to provide two degrees of freedom in each. A camera 15, for example a RaspiCam, is installed in head portion 12 and operatively connected to main control board 26 through CSI camera interface allowing the camera to be used to perform dynamic face detection, face tracking, and head pose estimation, and the like, as indicated by dotted lines 17. The Raspberry Pi3B on board wifi module 29 capabilities will allow the robot to act as a wireless access point for internet access and communication with a wifi-enabled user computer device 19 to facilitate robust communication with the accompanying web application 66 (FIG. 3). In the illustrated embodiment, the Raspberry Pi3B main control board 26, DC motors 24, arms 14a, 14b, legs 16a, 16b, head portion 12, torso housing 22 are all mounted to chassis 20. Further, an audio output connector 13 is included on main control board 26 for connecting to a speaker carried on robot device 10 so that the speaker is operatively associated with the main control board for the delivery of lesson content, as well as to verbalize robot behaviors for feedback, redirection, guidance and encouragement.

Robot Software Platform: Constituent parts of the robot software relate to five primary areas: (1) lesson receipt, processing by email, (2) lesson content parsing, restructuring for delivery by robot/app (algorithmic implementation), (3) robot behaviors during lesson delivery, (4) attentional tracking, (5) adaptive feedback (positive and redirecting robot behaviors).

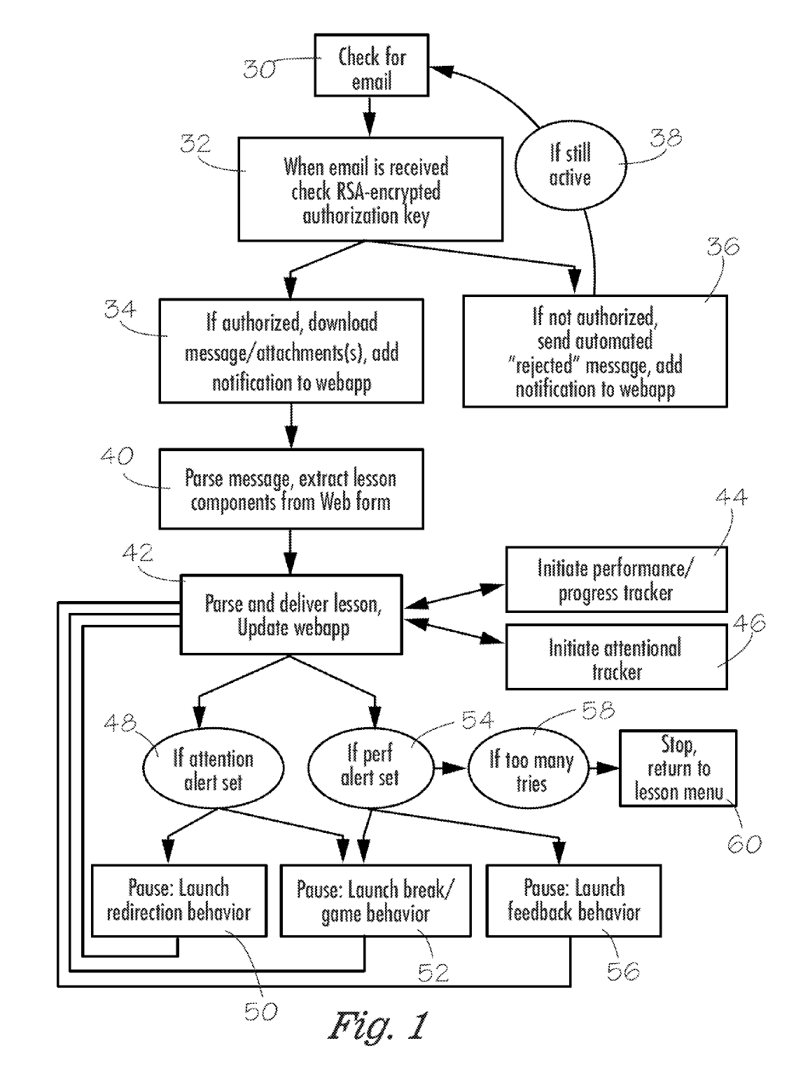

Referring to FIG. 1, a flowchart summarizing the robot's functional and social behaviors is provided. In step 30, the robot checks for email following power on. In step 32, when email is received, an RSA-encrypted authorization key is checked. In step 34, if authorization is successful, message/attachments for lesson content are downloaded to the robot and a notification is sent to the webapp of available lesson(s). In step 36, if authorization fails, an automated “rejected” message is provided and notification is sent to the webapp. In step 38, the email check and authentication process is reinitiated following rejection. In step 40, message information is parsed and lesson components extracted from a Web Form (described herein below) or online resources. In step 42, parse and deliver lesson content and update the webapp accordingly. In steps 44 and 46, performance and attention tracking are initiated. In step 48, if attention issues are determined, then redirection behavior or break/game behavior is initiated per steps 50 and 52, then the lesson deliver continues back to step 42. In step 54, if performance tracking issues are determined, the system launches feedback behavior or game/break behavior in steps 52 and 56. After a predetermined number of attempts per step 58, based on behavioral redirects, break/game behavior and feedback behavior in steps 50, 52, and 56, the lesson is stopped and returned to lesson menu on the webapp in step 60.

Receipt of lesson content through fundamental email, text message receipt and parsing to extract text for lesson content is implemented in C. Robot movement through basic motor control is implemented in Python. Robot speech for the delivery of lessons, feedback, redirection and encouragement is provided through a text-to-speech engine, for example Cereproc, which is implemented in Python. Webapp developed, communication with the robot as a wireless access point including features such as menus, lessons, image, video playback is implemented in Python.

The software platform also includes OpenCV for computational vision. Face detection and tracking is implemented in C++, and a face tracker algorithm (for example CLM or dLib in one embodiment) is used to perform head orientation and gaze (attentional) tracking.

The system also includes security protocols as noted in the flowchart of FIG. 1 at steps 30-38. First, secure authentication of users requesting lessons is performed via the associated online website. Second, an RSA encryption key is required before messages can be downloaded and decrypted by the robot, further restricting system access to known users with an appropriate public key. Upon acceptance, the robot will decrypt and load message content for parsing. Upon rejection, the message is deleted and a message is returned to the sender describing the failure.

Parsing algorithm: Creative Commons (CC) is an international nonprofit organization which provides an easily accessible set of free legal tools that allow educators and researchers to share and reuse information and media under a range of standardized terms. Many educators have moved toward publishing their teaching materials online using various licenses available through CC and K-12 Open Educational Resources Collaborative (OER). The system leverages the large library of freely available content published under open-access and CC-BY licenses to deliver quality instruction, for example math lessons, for K-8 students. The invention delivers lessons, practice exercises and assessments for each grade level (K-8), parsed using an augmented version of Python's HTMLParser class to identify html tags commonly used to format online data. A library of html tags embedded in open-access content is also provided for each source to augment those automatically identified by the HTMLParser. Once the appropriate tag delimiter is identified, the content will be re-formatted and saved to a clean file for the robot's use. To this end, a set of tag delimiters are defined which are capable of parsing four common constituent parts of Math lessons including: (1) Concept/skill introduction, (2) Step-by-step walk-through (guided), (3) Student practice (independent with feedback) and, (4) Assessment. A basic version of the algorithm design is described below:

Algorithm - Extract lesson text and images

open html file for reading

```
  open new output file for writing
  # extract the lesson title and write to file
  while (<title>) not found do
```

readline

```
  end while
  write tag delimiter <title> and title text to output file, write closing
  <title>
# extract the first lesson category and write to file
  while (<div class=”introduction”> or appropriate html intro tag
  delimiter) not found do
```

readline

```
  end while
  write tag delimiter <intro> and introduction text to output file
  while (closing <intro> tag) not found do
```

readline
write line to output file

```
  end while
  write closing <intro> tag
  // repeat for each of the four lesson component tags: introduction,
  guided practice,
  independent practice and assessment.
```

end

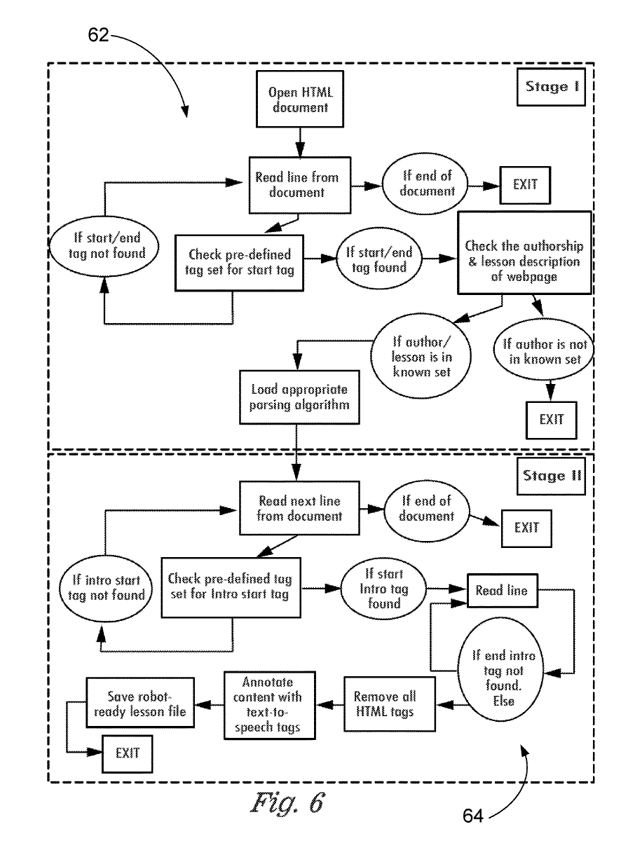

Referring to FIG. 6, four (4) or more lesson subsections will be parsed with the illustrated pseudocode including: (1) Introduction, (2) Guided practice, (3) Independent practice and (4) Assessment. In Stage I, designated generally as 62, the process involves scanning for a known authorship tag and lesson description to verify that an appropriate parsing algorithm and tag set exist for the document. If a matching author and lesson description is found, the parsing algorithm for the file is loaded for further processing the document. If a matching author and lesson description is not found, the document is flagged and the program exits. In Stage II, designated generally as 64, the document is parsed with the appropriate parsing algorithm and pre-defined tag set to extract the content for at least each of the four described subsections. If the source document is in a pdf format, an additional step of converting the pdf to a text file is required.

New content from recognized sources is tested using the parsing algorithm and compiled tag set to ensure accuracy of parsing output. Tag delimiters from new sources are automatically extracted and evaluated for suitability with existing algorithms. Tag sets are updated, as needed, to manage unrecognized tags for new lessons, exercises and assessments.

A critical component of this unique innovation is the robot's ability to provide embodied, personalized and adaptive interaction. During the lesson, practice and assessment delivery, adaptive robot behaviors will be interjected to provide guidance by redirecting attention, checking comprehension using regular performance testing and, if needed, offer further resources to provide added illustrations and support. Robot behaviors appropriate for each of the delineated lesson components will be implemented as described below.

Attentional tracking: Attentional tracking is a general robot behavior, automatically launched at the start of each lesson and active throughout practice exercises and assessment delivery. A combination of face and head orientation and tracking are achieved through the implementation of a face tracker algorithm.

Referring to FIG. 4, in one embodiment, student attention will be tracked using a standard web camera 15 and computational vision techniques such as Haar Features-based Cascade Classifiers and Constrained Local Model-based face tracking. The robot's RGB camera 15 captures video at least 30 frames per second (fps). To improve real-time performance, video may be down-sampled to no less than 1 fps. Upon booting up, the face tracker will search for the first detectable face. Once a face is detected, the algorithm will search subsequent frames employing a priori information based on the location of the previously detected face. Landmark features on the face are identified and Cartesian coordinates for each landmark point are used to determine head orientation. At the outset of each lesson, the robot 10 directs the child's attention to user compute device 19 and confirms their attention to the screen by requiring an on-screen task to continue with the lesson. This effectively localizes the screen of the user computer device 19 so the robot 10 can more accurately determine where the child is directing their attention. The robot primarily tracks two targets of attention: (1) the robot itself and (2) the screen. All other targets are recorded as “other”.

Lesson subsections are annotated to identify where the child's attention is expected (screen or robot). For example, when the robot is delivering the lesson introduction, the child's attention is mostly expected to be directed to the robot. During independent practice, however, it is expected that the child will direct their attention mostly look to the screen. Percentage of appropriate looking time will be determined based on the specific subsection of the lesson.

Re-direction: The first attention-contingent behavior is launched when inattention is detected, and the child has not already received 3 redirections during the lesson. Redirection consists of the robot calling the child's name, verbally directing his/her attention to the appropriate learning target (robot, screen) or using nonverbal cues such as pointing or looking to the screen.

Break/Game Behaviors: Once the child has been redirected 3 times during a single lesson, the robot will suggest a break (if the majority of the lesson is incomplete) or suggest a break (by inviting the child to stand up and join the robot in a stretching/dance exercise).

Initially, the interval of detected inattention that triggers the robot's redirecting behavior will be uniformly set for all users. Attentional tracking data may be collected to research individual variations in attention and performance. These data will contribute to an even more personalized approach for the robot. To this end, machine learning techniques are employed to learn typical attentional behavior for each individual and determine the optimal schedule for deploying redirection and break behaviors.

Performance tracking: The robot's performance-based behaviors fall into two categories: positive reinforcement and guidance. These supportive behaviors will be launched during practice exercises and assessments to reinforce student successes and to guide students using feedback that is specific to their individual performance and the specific lesson.

Positive Reinforcement: A set of encouraging robot behaviors in the form of verbal feedback and nonverbal gestures (high fives, fist bumps, clapping and celebratory dancing) is implemented and launched upon successful completion of a lesson or assessment. Additional reinforcing behaviors are launched after the student achieves success with a problem they previously did not complete correctly.

Guidance: Guidance is presented in the form of lesson-specific, verbal prompts during guided and student practice exercises. During guided exercises, the robot will check student performance incrementally and provide individualized guidance should the student's answer differ from the correct response at each step. Similarly, the robot will provide feedback pertaining to the student's performance at the completion of an independently completed exercise, using prompts from the lesson to guide the student's understanding. In the event of multiple unsuccessful trials, additional online resources will be offered.

Data Collection and Lesson Reporting:

During the delivery of each lesson, individual performance and attentional information is collected for each student. Upon completion of each lesson a progress report, consisting of predetermined information, is emailed to the parent or teacher who originated the lesson.

Examples of the types of information to be collected with regards to performance may include, but are not limited to:
A. Percentage of overall performance on assessment
B. Percentage of performance on each part of assessment
C. Comparison of overall performance with other similar lessons for this student
D. Comparison of overall performance with other students taking this lesson
E. Comparison of performance on each part of assessment with other students taking this lesson
F. List of questions missed
G. Topic areas relating to questions answered correctly
H. Topic areas relating to questions missed

Examples of the types of information to be collected with regards to attention may include, but are not limited to:
A. Percentage overall attention
B. Percentage attention during each lesson phase
C. Percentage attention during Introduction by concept area
D. Comparison of overall attention with other lessons for this student
E. Comparison of overall attention with other students taking this lesson
F. Comparison of attention to each concept area with other students taking this lesson
G. Percentage of attention during each intro concept area, percentage performance during each concept area

Examples of the types of information to be collected with regards to the overall lesson detail may include, but are not limited to:
A. Total time elapsed for lesson
B. Elapsed time by lesson component
   1. Time elapsed time in introduction
      a. Time elapsed during intro-concept 1
      b. Time elapsed during intro-concept 2
      c. Time elapsed during intro-concept 3
      d. Time elapsed during intro-concept n
   2. Time elapsed in guided practice
   3. Time elapsed in independent practice
   4. Time elapsed in assessment
C. If same student has already taken lesson, progress on same assignment for performance and attention overall and in each lesson part.

Examples of the types of information to be collected with regards to the overall student performance and attention (across all lessons for a given student) detail may include, but are not limited to:
A. Overall student performance for all lessons
B. Progressive student performance on similar lessons
C. Overall student attention for all lessons
D. Percentage overall attention during each lesson by phase
E. Percentage attention during Introduction by concept area
F. Comparison of overall attention with other students taking this lesson
G. Comparison of attention to each concept area with other students taking this lesson
H. Percentage of attention during each intro concept area, percentage performance during each concept area

Student's performance and attention statistics are computed as follows:
1. Percentage of overall performance on assessment:
   Total number of questions divided by the number of questions student answered correctly
2. Percentage of performance on each part of assessment:
   Total number of questions in each subsection of assessment divided by number of questions answered correctly for corresponding subsection
3. Comparison of overall performance with other similar lessons for this student:
   Graph is created using performance scores from previous lessons and current math lesson with similar focus
4. Comparison of overall performance with other students taking this lesson:
   Graph is created with overall performance scores from up to 1000 other similarly-aged students taking the same lesson
5. Comparison of performance on each part of assessment with other students taking this lesson:
   Graph is created with performance scores from up to 1000 other similarly-aged students taking the same lesson

Regarding performance tracking, in one embodiment, all student answers are input mouse clicks or the touchscreen of a connected wifi-enabled device. Each input will be compiled into a comprehensive report and securely stored by the robot for future reference.

Using the various above detailed data collection, the system implements machine learning techniques which track each child's performance and attention over time and adapt the delivery of lessons and feedback in an increasingly personalized way. This is accomplish by: 1. Collecting performance statistics on each lesson, for example, including (a) number of questions correctly answered, (b) specific questions/topics child answered incorrectly, (c) latencies between delivery of questions and answers, (d) Number of repeat misses; 2. Collecting attention statistics during each part of the lesson; and, 3. Collecting personal interests of child, for example, at the robot's request, the child provides a topic for the robot to research. The robot “researches” by web scraping information from Wikipedia and delivers a report at the next lesson session. The above performance evaluation and data collection are provided by way of example only, and the invention is not limited to these example embodiment as any type of information that is useful to improve machine learning and lesson content may be utilized.

Webapp: The Webapp provides an interactive interface for the child to follow lesson illustrations and to complete practice exercises and assessments. When the robot delivers lesson components or engages with the child socially, the Webapp interface is disabled to help the child focus their attention appropriately. During content illustrations, practice and assessment, the Webapp is enabled to allow for interactive user input.

In one embodiment, the accompanying webapp enables the robot to use any wifi-enabled device (including but not limited to, for example: tablet, laptop, PC, Mac) to display text, illustrations, audio and video to augment each lesson. Upon launching the Webapp, the student will be prompted to log in. Once the student's name is input, all “open-access” and individually assigned lessons for that student will appear on the Lesson Menu. The student selects a lesson and management of lesson delivery is transferred to the robot, including the display of text, images and video displayed on the wifi-enabled device (see sample of a sample lesson below). As noted above, the software algorithms leverage the sizable library of open-access online content to intelligently parse online lessons and assessments to make it as easy as point-and-click for educators to easily load existing, open-access content onto the robot. Referring to FIG. 3, an example of one embodiment of information displayed on a screen 66 of a wifi-enabled user computer device during a lesson is provided. This information can be arranged and delivered in any number of ways and the scope of the present invention is not confined to the illustrated example.

The robot-augmented education system is designed to supplement traditional classroom instruction through personalized, one-on-one guided practice. The robot system operates in a small space, requiring a desk and a small tablet (iPad-sized) or computer for displaying the Webapp. Specific lessons will be created and/or recommended by a student's teacher or, in the absence of a teacher recommendation, students can self-select from available lessons to enrich their understanding of specific math topics. Upon completion of each lesson, the student's progress report will be emailed to the teacher who originated the lesson. The robot learning system may be used to provide home-based after school support as well.

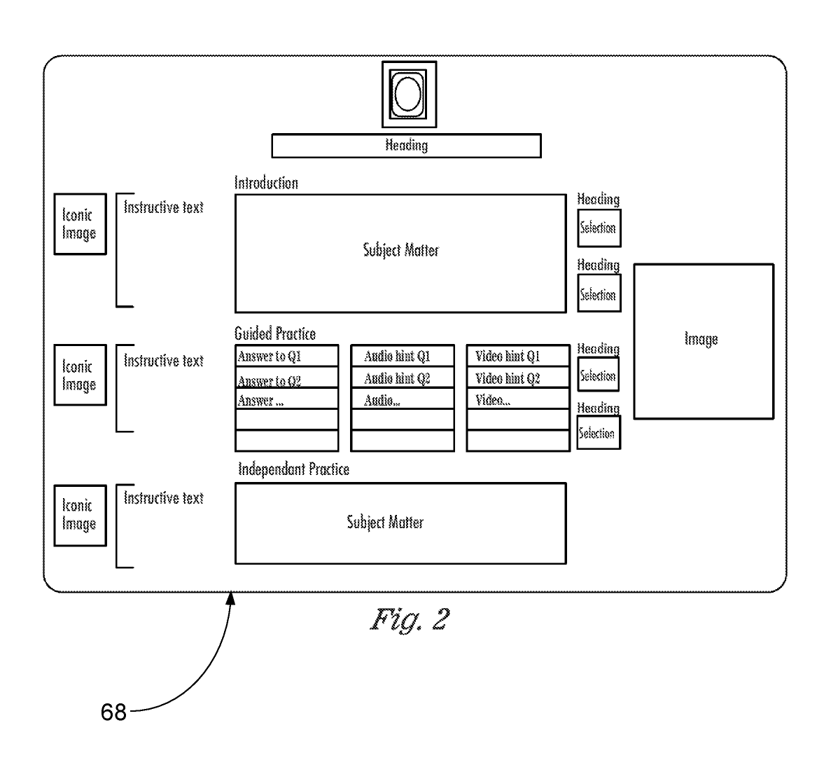

The WebForm: Referring to FIG. 2, a teachers' portal enables educators to copy and paste their own, custom-designed lessons into a web-based form, designated generally as 68, in the illustrated example. In one embodiment, the form includes multiple primary lesson components such as an: (a) introduction, (b) guided step-by-step instruction, (c) independent practice, and (d) assessment. Upon previewing and approving their lesson through an online website, teachers simply click the “Submit” button and the lesson is either emailed directly to the robot (when internet is present) or downloaded to be saved to a USB/flash drive for direct loading on the robot. The online WebForm, as shown in FIG. 2, is accessible through a website. In one embodiment, the website is a member's only website, however, membership is free and will be approved by the webmaster for the page, through verification of employment at a K-8 school. When a new member registers, they will be granted individual access and automatically added to their own school-group. The teachers' portal provides three access options for educators to share their custom lessons: (1) individual, (2) school-group and (3) open-access (anyone with a website membership). As a teacher creates new lessons, s/he can designate the desired level of accessibility for others. If, for example, the teacher would like to test a new lesson, the teacher may designate their lesson as “individual” access only. When they are ready to share, the teacher can upgrade access from “individual” to “school-group” or “open-access”.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. An interactive robot-augmented education system comprising:
an interactive robot device for providing embodied interactions with a user;
a user computer device in communication with said robot device for delivering lesson information to the user in combination with said robot device;
a user application operable on said user computer device that supports an interactive user interface enabling said robot device to display at least one of text, illustrations, audio and video, and combinations thereof, on said user computer device for delivering said lesson information; and,
said robot device including a camera adapted to conduct attention tracking of the user's face and head position during delivery of said lesson information and to provide positive feedback and redirection to the user during delivery of said lesson information based on information obtained as a result of said attention tracking to focus the attention of said user on one of said robot device or said user computer device.

2. The system of claim 1 wherein said robot device includes a chassis carrying a main control board having a camera interface, wherein said camera is operatively associated with said main control board through said camera interface to perform dynamic face detection, face tracking and head pose estimation to determine the focus of the user's attention during delivery of said lesson information.

3. The system of claim 2 wherein said camera is rotatably carried on said robot device to provide for both vertical and horizontal rotation to facilitate facial tracking of said user.

4. The system of claim 2 wherein said main control board includes an audio output connection, wherein a speaker is carried on said robot device and operatively associated with said main control board through said audio output connection to provide text-to-speech functionality in delivering lesson information and feedback to the user.

5. The system of claim 2 wherein said main control board includes a wifi module allowing said robot device to act as a wireless access point for internet access and communication with a wifi-enabled user computer device to facilitate communication with said user application.

6. The system of claim 2 wherein said robot device includes a torso, a pair of legs, a head, and a pair of arms mounted to said chassis, and wherein said head and arms are rotatably mounted on electric motors.

7. The system of claim 6 wherein said main control board includes a series of motor connectors, wherein said electric motors rotating said head and arms are operatively associated with said main control board through said motor connectors to control rotation of the head and arms.

8. The system of claim 1 wherein said robot device directs the user's attention at the beginning of delivering said lesson information to said user computer device and confirms the user's attention to a screen of said user computer device by requiring an on-screen task to continue with deliver of said lesson information to facilitate tracking of the user's face and head position.

9. The system of claim 8 wherein said robot device tracks two targets of attention for the user consisting of said robot device itself and said screen of said user computer device, and wherein said robot device records where the user's attention is focused throughout deliver of said lesson information.

10. The system of claim 9 wherein said lesson information is annotated to identify where the user's attention is expected to be directed for a given portion of said lesson information.

11. The system of claim 10 wherein said robot device detects inattention of the user by determining whether an appropriate percentage of looking time to said robot device or screen of said user computer device has been performed by said user based on the specific portion of said lesson information being delivered.

12. The system of claim 11 wherein said robot device initiates redirection behaviors directed to said user when inattention is detected to refocus the attention of the user on the appropriate target of said robot device or said screen of said user computer device.

13. The system of claim 12 wherein said redirection behaviors comprise the robot device calling the user's name, verbally directing the user's attention to the appropriate learning target of the robot device or screen of the user computer device, or using nonverbal cues including pointing and head rotation to direct the user's attention to the appropriate learning target.

14. The system of claim 13 wherein said robot device initiates game or break behaviors following a predetermined number of redirection attempts.

15. The system of claim 1 wherein said robot device initiates positive reinforcement behaviors in the form of verbal feedback and nonverbal gestures upon successful completion of a lesson or an assignment.

16. The system of claim 1 wherein said robot device initiates guidance behaviors in the form of lesson-specific verbal prompts during guided and user practice lessons to provide individualized guidance to lesson information.

17. The system of claim 1 wherein said robot device accesses said lesson information through internet based resources and performs lesson content parsing and restructuring to create a lesson with a plurality of subsections for delivery to a user.

18. The system of claim 17 wherein said plurality of subsections comprise an introduction portion, a guided practice portion, an independent practice portion, and an assessment portion.

19. The system of claim 18 wherein the lesson information for each of said plurality of subsections is extracted from said internet based resources based the parsing of html tags used to format online data.

20. An interactive robot-augmented education system comprising:
an interactive robot device for embodied interactions with a user, wherein said robot device accesses lesson information through internet based resources and performs lesson content parsing and restructuring to create a lesson for delivery to a user;
a user computer device in communication with said robot device for delivering said lesson to the user in combination with said robot device;
a user application operable on said user computer device that supports an interactive user interface to enable said robot device to display text, illustrations, audio and video on said user computer device for delivering said lesson information; and,
said robot device including a camera adapted to conduct attention tracking of the user's face and head position during delivery of said lesson information and to provide positive feedback and redirection to the user during delivery of said lesson information based on information obtained as a result of said attention tracking to focus the attention of said user on one of said robot device or said user computer device.
